(19) United States
(12) Patent Application Publication
(10) Pub. No.: US 2025/0341611 A1
(43) Pub. Date: Nov. 6, 2025

(54) WINDSHIELD LENS SYSTEM FOR VEHICLE LIDAR FIELD OF VIEW EXPANSION

(71) Applicant: GM GLOBAL TECHNOLOGY OPERATIONS LLC, Detroit, MI (US)

(72) Inventors: James S. Foresi, Bloomfield Hills, MI (US); Michelle Marie-Clem Brinker, St. Clair, MI (US)

(73) Assignee: GM GLOBAL TECHNOLOGY OPERATIONS LLC, Detroit, MI (US)

(21) Appl. No.: 18/653,597

(22) Filed: May 2, 2024

(51) Int. Cl. G01S 7/481; G01S 17/931; G02B 27/00

(52) U.S. Cl. CPC G01S 7/4812; G01S 17/931; G02B 27/0075

(57) ABSTRACT

A LiDAR system for a vehicle includes a LiDAR unit mounted inside a cabin of the vehicle and spaced away from a windshield of the vehicle. The LiDAR unit generates a transmitted beam and receives reflected light resulting from the transmitted beam. A lens system is mounted to the windshield and is positioned in a path of the transmitted beam and the reflected light, wherein the lens system is configured to expand the transmitted beam.

### INTRODUCTION

The present disclosure generally relates to light detection and ranging (LiDAR) systems and more particularly to LiDAR systems for mounting inside a mobile platform such as a vehicle to collect data on the environment external of the vehicle.

Applications such as vehicles may include one or more vehicle LiDAR units for use in collecting data for determining environment parameters such as distance, size and speed of objects by illuminating the objects with laser light and detecting the reflected light with sensors installed in the LiDAR receiver. The LiDAR system may be used for environmental perception such as to determine information related to objects surrounding the vehicle. The information may be provided for use to one or more vehicle systems in a point-cloud format, such as autonomous driving systems.

LiDAR units may typically be mounted on the exterior of the vehicle. For example, the units may be mounted in the front grill area of a vehicle or on the roof. Such vehicle LiDARs may have light sending and receiving efficiency reductions when exposed to commonly encountered contaminant elements such as rain, snow, dirt and salt, which may accumulate on the lens cover area of the unit. A challenge exists to ensure reliable environment perception under the influence of environmental conditions such water and particles on the sensor. The presence of contaminant elements may affect the perception performance of the LiDAR sensor. For example, they may reduce the range or partly obscure a LiDAR sensor's perception leading to decreased detection capabilities. Contaminant elements may change the field of view, and/or they may lead to a reduction in fidelity of physical measurement quantities such as distance measurements.

Accordingly, it is desirable to ensure that LiDAR sensing is effectively accomplished regardless of the exterior environmental conditions. In addition, the solutions to providing such effectiveness are preferably accomplished while delivering sufficient field-of-view coverage of the LiDAR system. Furthermore, other desirable features and characteristics of the present invention will become apparent from the subsequent detailed description and the appended claims, taken in conjunction with the accompanying drawings and the foregoing introduction.

### SUMMARY

LiDAR systems are provided that facilitate mounting the LiDAR transmitting and receiving unit inside a vehicle. In a number of embodiments, a LiDAR system for a vehicle includes a LiDAR unit that is mounted inside a cabin of the vehicle and that is spaced away from a windshield of the vehicle. The LiDAR unit generates a transmitted beam and receives reflected light resulting from the transmitted beam. A lens system is mounted to the windshield and is positioned in a path of the transmitted beam and the reflected light, wherein the lens system is configured to expand the transmitted beam.

In additional embodiments, the lens system includes a plano-concave lens mounted to the windshield.

In additional embodiments, the LiDAR unit includes lens optics internal to the LiDAR unit so that the transmitted beam is directed to pass through both the lens optics and the lens system.

In additional embodiments, the LiDAR unit generates the transmitted beam with a field of view, and the lens system increases the field of view.

In additional embodiments, the transmitted beam and the reflected light both pass through the lens system.

In additional embodiments, the windshield includes an infrared shielding material that is modified in a window area of the windshield through which the transmitted beam passes to reduce an effect of the infrared shielding material on the transmitted beam.

In additional embodiments, the LiDAR unit includes lens optics with a coaxial lens through which both the transmitted beam and the reflected light pass.

In additional embodiments, the lens system includes a lens that has a lens surface facing the windshield. The lens surface has a contour that matches a contour of an interior surface of the windshield so that the lens mates with the windshield.

In additional embodiments, a light tray encloses the field of view in the cabin without violating vehicle up-vision requirements.

In additional embodiments, the lens system multiplies a field of view of the transmitted beam in multiple axes, after the transmitted beam has left the LiDAR unit.

In a number of additional embodiments, a LiDAR system for a vehicle includes a cabin of the vehicle that is defined in-part by a windshield of the vehicle, where the cabin is inside the vehicle. A LiDAR unit is mounted inside the cabin of the vehicle and is spaced away from the windshield of the vehicle. The LiDAR unit generates a transmitted beam and receives reflected light resulting from the transmitted beam to perceive objects external to the cabin. A lens system is mounted to the windshield and is positioned to pass the transmitted beam and the reflected light. The lens system is expands the transmitted beam by increasing a field of view of the transmitted beam, after the transmitted beam has left the LiDAR unit.

In additional embodiments, the lens system includes a plano-concave lens mounted to the windshield. The plano-concave lens has an inward curved surface facing the LiDAR unit.

In additional embodiments, the LiDAR unit includes lens optics internal to the LiDAR unit. The lens optics generate the transmitted beam with a field of view within the cabin.

In additional embodiments, the LiDAR unit generates the transmitted beam with a field of view within the cabin. The lens system increases the field of view external to the cabin.

In additional embodiments, the transmitted beam and the reflected light both pass through the lens system which refracts the transmitted beam.

In additional embodiments, the windshield includes an infrared shielding material that is modified in a window area of the windshield through which the transmitted beam passes to reduce an effect of the infrared shielding material on the transmitted beam.

In additional embodiments, the LiDAR unit includes lens optics with a coaxial lens through which both the transmitted beam and the reflected light pass, the lens optics generating the transmitted beam with a field of view inside the cabin.

In additional embodiments, the lens system includes a lens with a lens surface facing the windshield. The lens surface has a contour that matches a contour of an interior surface of the windshield, where the lens mates with, and is fixed to, the windshield.

In additional embodiments, the lens system multiplies a field of view of the transmitted beam, after the transmitted beam has left the LiDAR unit. Exterior to the cabin, the field of view of the transmitted beam is larger than inside the cabin.

In a number of other embodiments, a LiDAR system for a vehicle includes a cabin defined by a windshield of the vehicle and a body of the vehicle, where the cabin is inside the vehicle. A LiDAR unit is mounted inside the cabin of the vehicle and is spaced away from the windshield of the vehicle. The LiDAR unit generates a transmitted beam and receives reflected light resulting from the transmitted beam to perceive objects external to the cabin. A lens system is mounted to the windshield and is positioned to pass the transmitted beam and the reflected light. The lens system expands the transmitted beam by multiplying a field of view of the transmitted beam, after the transmitted beam has left the LiDAR unit so that the field of view is larger outside the cabin as compared to inside the cabin.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of the azimuth coverage of a LiDAR system in a vehicle, in accordance with an embodiment;

FIG. 2 is schematic illustration of the elevation coverage of a LiDAR system in a vehicle, in accordance with an embodiment;

FIG. 3 is a schematic illustration of a LiDAR unit of the vehicle of FIG. 1 with a retainer in the housing, in accordance with various embodiments;

FIG. 4 is a schematic diagram of a LiDAR system with a remote windshield lens system, in accordance with various embodiments;

FIG. 5 is a schematic diagram of a LiDAR system with a single lens as the lens system and windshield rake correction, in accordance with various embodiments;

FIG. 6 is a schematic diagram of a LiDAR system with plural lenses as the lens system and windshield rake correction, in accordance with various embodiments;

FIG. 7 is a diagram of the transmitted beam from a side view intersecting the windshield for a LiDAR system with remote lens system as compared to without a remote lens system with distance in millimeters in both the vertical direction and the horizontal direction, in accordance with various embodiments; and

FIG. 8 is a diagram of the transmitted beam intersecting a windshield at the plane of the windshield for a LiDAR system with remote lens system as compared to without a remote lens system with distance in millimeters in both the vertical direction and the horizontal direction, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description.

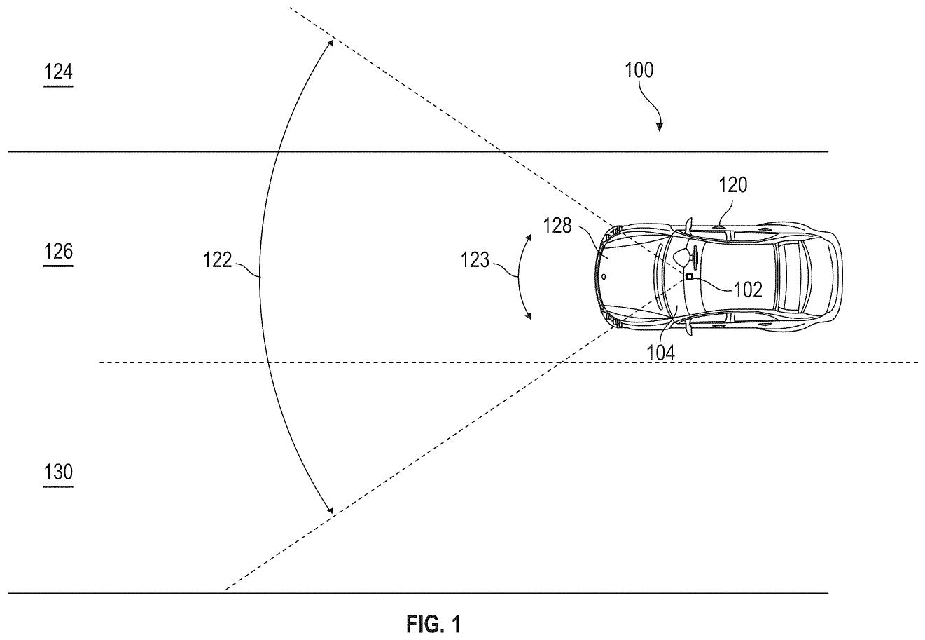

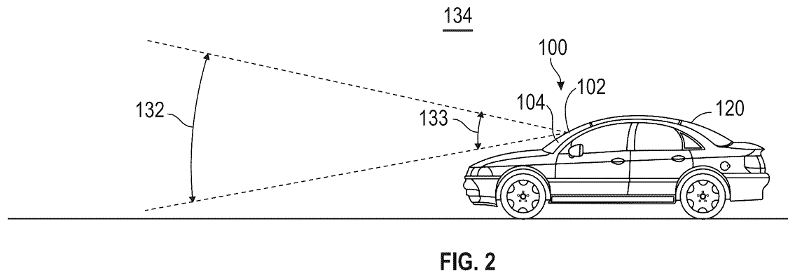

With reference to FIG. 1, illustrated is a LiDAR system 100 onboard a vehicle 120 having a body 128. The LiDAR system 100 may be applied to a vehicle 120 to cover a particular area, in this example to cover the area in front of a vehicle 120. It should be understood that additional LiDAR systems may be included, such as to provide LiDARs with different coverages around the vehicle 120. In embodiments, LiDAR systems may be used for environment perception in multiple directions such as at the sides of the vehicle 120 and/or at the rear of the vehicle 120. The LiDAR system 100 may be used to scan a three-dimensional space outside the vehicle 120 within its field-of-view. For purposes of the present description, FIGS. 1 and 2 depict the field of view as represented by horizontal (azimuth) and vertical (elevation) ranges. Field of view is the angular extent of the observable world that is perceived by the LiDAR system 100.

The field of view of the LiDAR system 100 depends on its construction, control and mounting, in this example on the vehicle 120. FIG. 1 depicts the coverage angle 122 of the LiDAR system 100 in the azimuth plane 124, where in the current embodiment, the LiDAR system 100 includes a LiDAR unit 102 that is inside the vehicle 120 and scanning through the windshield 104. For a mid-range LiDAR system 100 the angle 122 may be 120-degrees, as an example. In other embodiments, a larger angle 122 may be desirable for wider coverage. In some embodiments, the coverage width angle 122 may be tailored to cover a single road lane 126 and as such would have a field of view with an angle 123 of approximately 30-degrees total. For a field of view, such as to cover two road lanes 126 and 130, the field of view to cover the area of perception, for example, may be 60-degrees as the angle 122. In general, a wider coverage width is desirable for additional perception to capture targets moving in front and laterally relative to the vehicle 120. In other embodiments, the field of view is selected for the application. For example, an even wider field of view may be selected to perceive objects to the left and/or the right of the roadway.

FIG. 2 depicts the coverage height 133 of the LiDAR system 100 in the vertical plane 134. In the vertical plane 134 the coverage may be narrower as compared to the horizontal plane. In the current embodiment, and as further described below, the coverage width in the vertical plane 134 provided by the LiDAR system 100 is at an angle 132 of a desired number of degrees, such as 25-degrees. In other embodiments, another number of degrees of the angle 132 may be desirable. The LiDAR system 100 is constructed to provide the desired coverage in both the horizontal plane and the vertical plane.

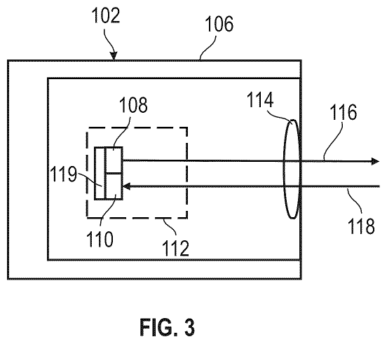

Referring to FIG. 3, the LiDAR unit 102 is schematically illustrated. While the LiDAR unit 102 is constructed in a coaxial configuration in the depicted embodiment, this disclosure is also applicable to biaxial and other configurations. For example, a biaxial configuration may be used with a complementary lens system. The LiDAR unit 102 in general, may include a housing 106, a light source 108 such as an infrared laser transmitter, a photo detecting receiver 110, a beam steering unit 112 for scanning, such as an encoder, which may or may not employ a mirror, and optics 114, such as one or more lenses. The transmitted beam 116 and the reflected light 118 pass through the lens optics 114 and through the same lens or lenses thereof. As noted, the optics 114 may be coaxial with the transmitted beam 116 and the reflected light 118 passing through the same lens or series of lenses or, the optics 114 may be biaxial where the transmitted beam 116 passes through one lens or series of lenses and the reflected light passes through another lens or series of lenses. In some embodiments, the transmitter may be of the solid state type without moving parts such as without the beam steering unit 112. In some embodiments, the light source 108 may be a single laser beam to illuminate objects, while in other embodiments, multiple beams may be used. In some embodiments, devices such as MEMS or beam steering may be used to manipulate the transmitted beam 116 to scan a desired field of view.

The LiDAR unit 102 generates the transmitted beam 116 that is directed, such as to perceive objects. The objects may be any object external to the vehicle 120, such as another vehicle, a pedestrian, a utility pole, etc. The reflected light 118, which is directed back due to interaction of the transmitted beam 116 with objects, is received back at the LiDAR unit 102. A processor 119 controls various operations of the LiDAR system 100 such as controlling the light source 108 of the LiDAR system 100, etc. The processor 119 further receives data for the LiDAR system 100, such as related to differences between the transmitted beam 116 and the reflected light 118, and determines various parameters of objects from this data. The various parameters may include a distance to, or range of the objects, azimuth location, elevation, velocity of the object, etc. The vehicle 120 may further include an advanced driver assistance system (not shown) that uses these parameters for various purposes, such as navigation of the vehicle 120 with respect to the road lane 126, taking the objects into consideration.

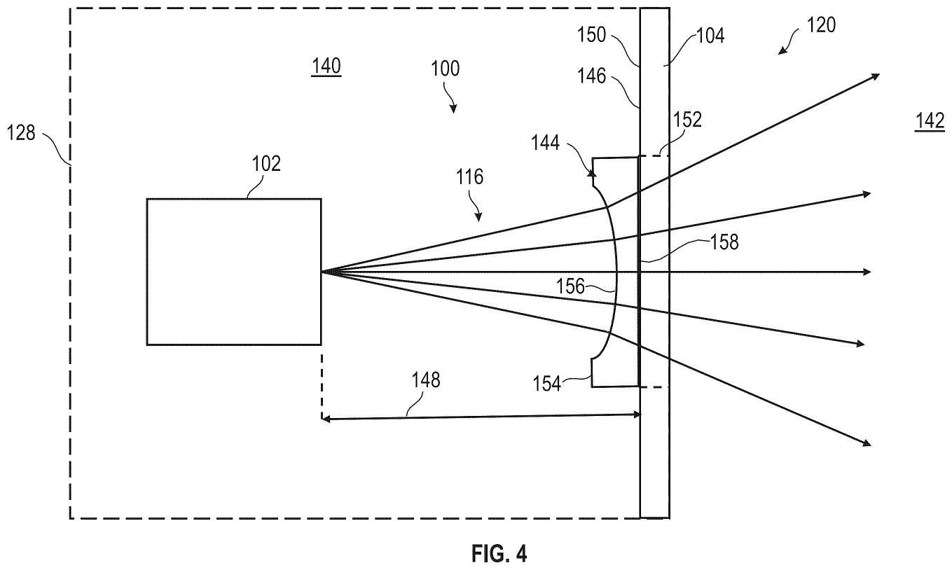

The area of the LiDAR field of view increases as the distance from the LiDAR unit 102 output surface increases. Referring to FIG. 4, a view from above is shown. The LiDAR unit 102 is illustrated inside the cabin 140 of the vehicle 120. Part of the cabin 140 is defined by the windshield 104 of the vehicle 120 and by the body 128. The transmitted beam 116 is directed to the exterior 142 of the vehicle 120 through the windshield 104. A lens system 144 is mounted at the windshield 104 so that the transmitted beam 116 must pass through the lens system 144 and the windshield 104 to reach the exterior 142. In embodiments, the lens system 144 may be fixed to the windshield 104 or otherwise held at and against the interior surface 146 of the windshield 104. In the current embodiment, the lens system 144 is a single lens. In other embodiments, the lens system 144 may employ multiple stacked lenses to provide the desired optical effect, which is to expand the field of view of the transmitted beam 116 as it passes through the lens system 144. For example, the field of view may be increased by a desired factor, such as doubling, by the lens system 144. In a specific example, the horizontal view may be converted from 60-degrees as generated by the LiDAR unit 102 to 120-degrees after passing through the lens system 144. In the example, the vertical view may be increased from 12.5-degrees as generated by the LiDAR unit 102 to 25-degrees after passing through the lens system 144. The effect is that the desired field of view is provided at the exterior 142 to scan for objects, while the field of view in the cabin 140 may be smaller. A smaller field of view in the cabin 140 provides benefits such as the ability to place the LiDAR unit 102 at a distance 148 to the windshield 104 that is closer than would otherwise be possible without the lens system 144. The area of the transmitted beam 116 may be surrounded by a housing or walled structure to enclose the area and prevent interference with the transmitted beam 116 and the reflected light 118. Placing the LiDAR unit 102 closer to the windshield 104 simplifies protecting the keep out zone occupied by the transmitted beam 116.

The LiDAR unit 102 may operate using infrared light for the transmitted beam 116. The windshield 104 may generally include an ultraviolet and/or infrared shielding material such as a coating 150 on the interior surface 146, although the material may be at a different location in, or on, the glass of the windshield 104. To facilitate transmission of the transmitted beam 116 through the windshield 104, a beam window 152 is provided at the same location as the lens system 144 where the coating 150/material is treated, such as by being removed, omitted or otherwise modified to eliminate or reduce its effect on the transmitted beam 116 and the reflected light 118. For example, so that the coating 150 of the windshield 104 does not interfere with transmission of the transmitted beam 116 and the reflected light 118 the beam window 152 is provided where the coating 150 is not present or neutralized.

The LiDAR unit 102 is placed with consideration for the angles at which the transmitted beam 116 across its full field of view intersects the windshield 104. The range of angles at which the transmitted beam 116 intersect the windshield 104 define an area (cross-section of the field of view between the LiDAR unit 102 and the windshield 104) referred to as the keep out zone, which limits placement of the LiDAR unit 102 in the cabin 140. The keep out zone is the full field of view of the LiDAR inside the vehicle 120 from the LiDAR unit 102 to the windshield 104 that is to be unobstructed to accurately perceive the external environment. Any features that block the field of view are not acceptable and the LiDAR unit 102 and its location are designed to avoid objects and passengers in the vehicle 120 interfering with the field of view. The field of view may be described as a three-dimensional space that expands from the output of the LiDAR unit 102 to the windshield 104, that is the keep out zone. The larger the field of view exiting the LiDAR unit 102 and propagating to the windshield 104, the larger the keep out zone.

The angles at which the transmitted beam 116 strikes the windshield 104 (angle of incidence) determines the amount of the transmitted beam 116 that is reflected off the windshield 104 rather than penetrating it. The larger the field of view of the transmitted beam 116 at the windshield 104, the greater the angles and the more light that is reflected. The reflection loss may occur both for the transmitted beam 116 and for the return/reflected light 118 that has reflected from an object. The lens system 144 expands the field of view of the transmitted beam 116. Therefore, the field of view size inside the cabin 140 may be much smaller than what would otherwise result in an acceptable field of view size at the exterior 142, without the lens system 144. This smaller keep out zone makes placement of the LiDAR unit 102 and the design of its mounting in the vehicle 120 easier. In addition, it may increase penetration of the transmitted beam 116 through the windshield 104 by reducing reflectance, thereby improving perception. In some embodiments, a light tray may be used to fully enclose the field of view without violating vehicle up-vision requirements, which reduces losses due to reflection at the air/glass interfaces in the beam path. Up-vision requirements describe how far down the windshield any “black out” material may be installed.

In the current embodiment, the lens system 144 includes a lens 154 that is generally of the plano-concave type, but the disclosure is not limited to that type of lens and may include other configurations such as diffractive optics. The lens 154 has a concave (inward curved) surface 156 facing the LiDAR unit 102. The lens 154 is an element is that transparent and made of glass, plastic, or some other material, with the surface 156 that is curved, and bends (refracts) the direction of light as it passes through the lens 154. The lens 154 has a surface 158 contacting the windshield 104. The surface 158 has a contour that matches the contour of the interior surface 146 of the windshield 104 so that the lens 154 mates with the windshield without air pockets in-between. The lens 154 is selected for its beam expanding properties, which amplifies the field of view. Refraction occurs when the transmitted beam 116 passes through a boundary at the surface 156 between the air in the cabin 140 and the glass of the lens 154. When the light of the transmitted beam 116 passes through the plano-concave lens 154, the curvature of the lens surface 156 causes the light rays to bend away from each other. This causes the light to diverge. The lens 154 may be mounted to the windshield 104 by a variety of means such as by being captured within a bezel (not shown) fixed to the windshield, by being adhered to the windshield, by being fused to the windshield, or by other means.

An advantage of the lens 154 is that the angles at which the transmitted beam 116 intersect the windshield may be reduced, reducing reflection and increasing penetration, while the field of view in the exterior 142 is desirably large enough for covering the perception of objects in the environment. In other words, the field of view of the transmitted beam 116 is small enough inside the cabin 140 to avoid excessive reflection and to minimize the keep out zone, and yet large enough in the exterior 142 to effectively scan for objects by being expanded by the lens 154.

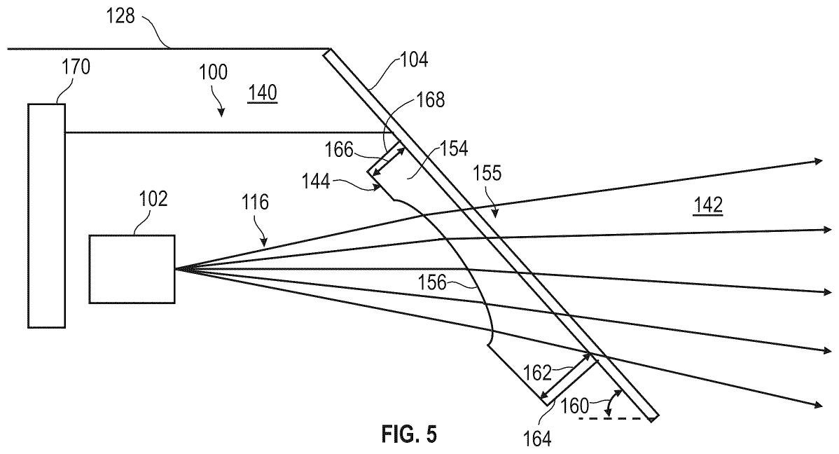

Referring to FIG. 5, a side view of the LiDAR system 100 is illustrated showing the LiDAR unit 102 transmitting the transmitted beam 116 from a position inside the cabin 140, through the lens system 144 and the windshield 104 to the exterior 142 to scan for objects. The windshield 104 is disposed to have a rake angle 160 measure from the horizontal plane. The rake angle 160 may be selected based on aerodynamic and styling considerations of the vehicle 120. Generally, the top of the windshield 104 is disposed at a location on the vehicle 120 that is farther rearward than the bottom of the windshield 104. The result is that the angles at which the transmitted beam 116 intersect the windshield 104 are a factor of the rake angle 160. As a result, the lens system 144 is arranged so that the surface 156 and the optics of the lens 154 correct for the rake angle 160 in minimizing reflection, while expanding the field of view outside the cabin 140 in the exterior 142. For example, the lens 154 may have a thickness 162 near its bottom 164, that is larger than its thickness 166 at its top 168. The specific physical dimensions of the lens system 144 may vary, with the objective being to compensate for the rake angle 160.

As shown in FIG. 5, the LiDAR unit 102 may be disposed between the rearview mirror 170 and the windshield 104. The rearview mirror 170 may be a mirror mounted in the cabin 140 for use by the driver of the vehicle 120 in observing areas behind the vehicle 120. The rearview mirror 170 may be suspended from the windshield 104 or from the body 128 of the vehicle 120. Because the LiDAR unit 102 is mounted between the rearview mirror 170 and the windshield 104, the ability to address the angles at which the transmitted beam 116 intersects the windshield 104 by placement of the LiDAR unit 102 is limited. Accordingly, the lens system 144 is beneficial in providing the desirable characteristics of the transmitted beam 116 for perceiving objects without deviating from the limited mounting positions. Placing the LiDAR unit 102 between the rearview mirror 170 and the windshield 104 makes protecting the keep out zone easier. In addition, placement of the lens 154 at a location in front of the rearview mirror 170 positions it to direct the transmitted beam 116 through a wipe zone 155 where the wipers of the vehicle 120 clean the windshield 104, removing water and other materials that could interfere with the LiDAR system 100.

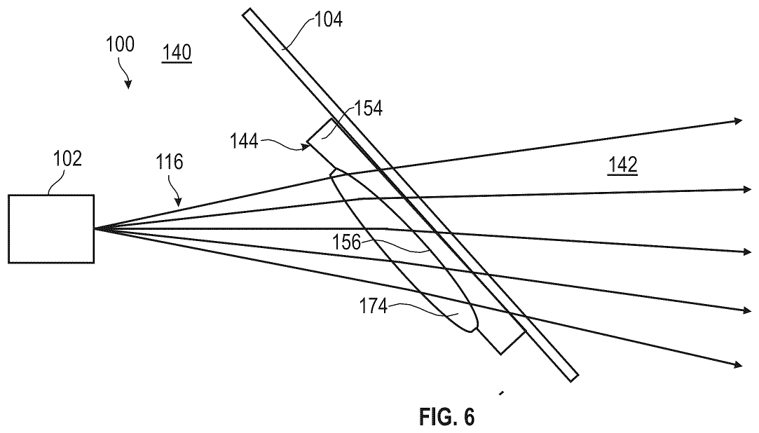

Referring to FIG. 6, the LiDAR system 100 is shown in schematic form from a side view perspective similar to FIG. 5. In this example, the lens system 144 includes plural lenses in this case two lenses including lens 154 and lens 174. In some embodiments, to avoid undesirable reflection, while compensating for the rake angle 160 of the windshield 104 and providing a preferred field of view at the exterior 142, a plural number of lenses may be employed for the desired optical effect. In this case the plano-concave type lens 154 is combined with the biconvex lens 174 to obtain the desired optical effect. In other embodiments, another multiple lens arrangement with different types of lenses may be employed.

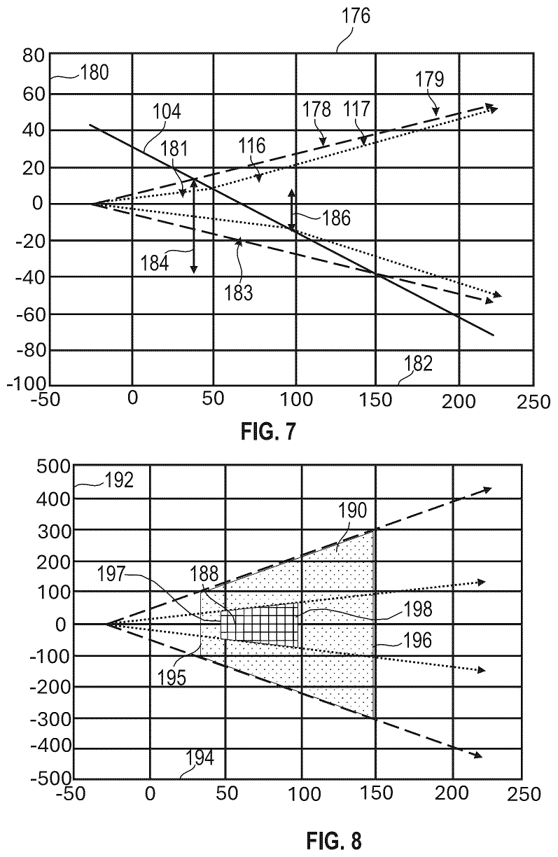

Referring to FIG. 7, a diagram 176 shows a comparison between the transmitted beam 116 when produced in the LiDAR system 100 with the lens system 144, and a lens-free transmitted beam 178 without the lens system 144 to achieve the desired field of view at the exterior 142. The diagram of FIG. 7 is from the side of the transmitted beam 116 showing the vertical condition approaching, at, and outside the windshield 104. The diagram 176 charts distance in millimeters in the vertical direction/axis 180 with zero being at the center of the beam transmission point of the LiDAR unit 102. The diagram 176 shows distance in millimeters in the horizontal direction/axis 182 with zero being at the forward end of the LiDAR unit 102. The dotted lines show the maximum vertical coverage in the up and down directions for the transmitted beam 116 over its field of view 117 and the dashed lines show the same for lens-free transmitted beam 178 over the field of view 179. In each case, the transmitted beam 116 and the lens-free transmitted beam 178 are configured to provide the same field of view at a select location in the exterior 142 of the vehicle 120. The vertical range/distance 180 over which the lens-free transmitted beam 178 intersects the windshield 104 is fifty-one (51) millimeters over the field of view 179. The vertical range/distance 182 over which the transmitted beam 116 with lens system 144 intersects the windshield 104 is twenty-one (21) millimeters over the field of view 117. The smaller vertical range/distance 182 means that the transmitted beam 116 with the lens system 144 intersects the windshield at substantially smaller maximum angles as compared to lens-free transmitted beam 178. Accordingly, the keep out zone 181 of the transmitted beam 116 is smaller than the keep out zone 183 of the lens-free transmitted beam 178 and less reflection occurs and greater penetration to the exterior 142 is achieved for object perception.

Referring to FIG. 8, a diagram 186 shows the field of view footprint 188 (trapezoidal area) at the windshield 104 of the transmitted beam 116 when produced in the LiDAR system 100 with the lens system 144, and the field of view footprint 190 (trapezoidal area) of the lens-free transmitted beam 178 without the lens system 144 at the windshield 104. In each case the beams are generated to achieve the same desired field of view at the exterior 142. The area of the field of view footprint 190 includes the area of the field of view footprint 188. The diagram of FIG. 8 is at the windshield 104 (in the same plane) showing the area of the beams and the vertical and horizontal extent of the beams at the windshield 104. The diagram 186 charts distance in millimeters in the vertical direction/axis 192 and distance in millimeters in the horizontal direction/axis 194. The dotted lines show the maximum horizontal coverage in the left and right directions for the transmitted beam 116 over its field of view and the dashed lines show the same for lens-free transmitted beam 178. In each case, the transmitted beam 116 and the lens-free transmitted beam 178 are configured to provide the same field of view at a select location in the exterior 142 of the vehicle 120. The horizontal range/distance 195 over which the lens-free transmitted beam 178 intersects the windshield 104 at the top of its field of view footprint 190 is two-hundred-fourteen (214) millimeters. The horizontal range/distance 196 over which the lens-free transmitted beam 178 intersects the windshield 104 at the bottom of its footprint 190 is five-hundred-ninety-six (596) millimeters. The horizontal range/distance 197 over which the transmitted beam 116 of the LiDAR system 100 intersects the windshield 104 at the top of its footprint 190 is eighty-six (86) millimeters. The horizontal range/distance 198 over which the transmitted beam 116 intersects the windshield 104 at the bottom of its footprint 190 is one-hundred-thirty-four (134) millimeters. The smaller horizontal range/distances 197, 198 means that the transmitted beam 116 with the lens system 144 intersects the windshield at substantially smaller maximum angles as compared to lens-free transmitted beam 178. As a result, a smaller keep out zone is required and less reflection occurs and greater penetration to the exterior 142 is achieved for object perception.

Accordingly, LiDAR systems include an external lens mounted to the windshield to meet the LiDAR field of view requirements, to reduce the keep out zone's size within the vehicle and where the field of view intersects the windshield and to limit reflections from the windshield. The invention simplifies the ability to mount a LiDAR in-cabin and still meet LiDAR performance requirements. The additional lens at the windshield allows the field of view in-cabin to remain compact and provides the final required field of view external to the vehicle. In addition, the area on the windshield is reduced in size where the removal/treatment of infrared rejection coatings is required.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A LiDAR system for a vehicle comprising:
a LiDAR unit mounted inside a cabin of the vehicle and spaced away from a windshield of the vehicle, the LiDAR unit configured to generate a transmitted beam and to receive reflected light resulting from the transmitted beam; and
a lens system mounted to the windshield and positioned in a path of the transmitted beam and the reflected light, wherein the lens system is configured to expand a field of view of the transmitted beam.

2. The LiDAR system of claim 1, wherein the lens system comprises a plano-concave lens mounted to the windshield.

3. The LiDAR system of claim 1, wherein the LiDAR unit comprises lens optics internal to the LiDAR unit so that the transmitted beam is configured to pass through both the lens optics and the lens system.

4. The LiDAR system of claim 1, wherein the LiDAR unit is configured to generate the transmitted beam with a field of view, and wherein the lens system is configured to increase the field of view.

5. The LiDAR system of claim 1, wherein the transmitted beam and the reflected light both pass through the lens system.

6. The LiDAR system of claim 1, wherein the windshield includes an infrared shielding material that is modified in a window area of the windshield through which the transmitted beam passes to reduce an effect of the infrared shielding material on the transmitted beam.

7. The LiDAR system of claim 1, wherein the LiDAR unit includes lens optics with a coaxial lens through which both the transmitted beam and the reflected light pass.

8. The LiDAR system of claim 1, wherein the lens system includes a lens that has a lens surface facing the windshield, wherein the lens surface has a first contour that matches a second contour of an interior surface of the windshield so that the lens mates with the windshield.

9. The LiDAR system of claim 1, comprising a light tray enclosing the field of view in the cabin without violating vehicle up-vision requirements.

10. The LiDAR system of claim 1, wherein the lens system is configured to multiply a field of view of the transmitted beam in multiple axes, after the transmitted beam has left the LiDAR unit.

11. A LiDAR system for a vehicle comprising:
a cabin of the vehicle defined in-part by a windshield of the vehicle, wherein the cabin is inside the vehicle;
a LiDAR unit mounted inside the cabin of the vehicle and spaced away from the windshield of the vehicle, wherein the LiDAR unit is configured to generate a transmitted beam and to receive reflected light resulting from the transmitted beam to perceive objects external to the cabin; and
a lens system mounted to the windshield and positioned to pass the transmitted beam and the reflected light, wherein the lens system is configured to expand the transmitted beam by increasing a field of view of the transmitted beam, after the transmitted beam has left the LiDAR unit.

12. The LiDAR system of claim 11, wherein the lens system comprises a plano-concave lens mounted to the windshield, the plano-concave lens having an inward curved surface facing the LiDAR unit.

13. The LiDAR system of claim 11, wherein the LiDAR unit comprises lens optics internal to the LiDAR unit, and the lens optics are configured to generate the transmitted beam with a field of view within the cabin.

14. The LiDAR system of claim 11, wherein the LiDAR unit is configured to generate the transmitted beam with a field of view within the cabin and wherein the lens system is configured to increase the field of view external to the cabin.

15. The LiDAR system of claim 11, wherein the transmitted beam and the reflected light both pass through the lens system which refracts the transmitted beam.

16. The LiDAR system of claim 11, wherein the windshield includes an infrared shielding material that is modified in a window area of the windshield through which the transmitted beam passes to reduce an effect of the infrared shielding material on the transmitted beam.

17. The LiDAR system of claim 11, wherein the LiDAR unit includes lens optics with a coaxial lens through which both the transmitted beam and the reflected light pass, the lens optics generating the transmitted beam with a field of view inside the cabin.

18. The LiDAR system of claim 11, wherein the lens system includes a lens with a lens surface facing the windshield, wherein the lens surface has a first contour that matches a second contour of an interior surface of the windshield, wherein the lens mates with, and is fixed to, the windshield.

19. The LiDAR system of claim 11, wherein the lens system is configured to multiply a field of view of the transmitted beam, after the transmitted beam has left the LiDAR unit, wherein exterior to the cabin, the field of view of the transmitted beam is larger than inside the cabin.

20. A LiDAR system for a vehicle, comprising:
a cabin defined by a windshield of the vehicle and a body of the vehicle, wherein the cabin is inside the vehicle;
a LiDAR unit mounted inside the cabin of the vehicle and spaced away from the windshield of the vehicle, the LiDAR unit configured to generate a transmitted beam and to receive reflected light resulting from the transmitted beam to perceive objects external to the cabin; and
a lens system mounted to the windshield and positioned to pass the transmitted beam and the reflected light, wherein the lens system is configured to expand the transmitted beam by multiplying a field of view of the transmitted beam, after the transmitted beam has left the LiDAR unit so that the field of view is larger outside the cabin as compared to inside the cabin.
